(19) United States
(12) Patent Application Publication
(10) Pub. No.: US 2016/0014130 A1
(43) Pub. Date: Jan. 14, 2016

(54) APPARATUS AND METHOD FOR USING AUDIO CONNECTORS TO ENABLE A WEB PAGE TO ACCESS PERIPHERALS NOT SUPPORTED BY A WEB BROWSER

(71) Applicant: On Track Innovations, Ltd., Rosh Pina (IL)

(72) Inventor: Guy LIVNEH, Upper Galilee (IL)

(21) Appl. No.: 14/564,698

(22) Filed: Dec. 9, 2014

Related U.S. Application Data
(60) Provisional application No. 62/023,280, filed on Jul. 11, 2014.

(51) Int. Cl. H04L 29/06; G06F 3/16; H04L 29/08

(52) U.S. Cl. CPC H04L 63/10; H04L 67/02; H04L 67/16; H04L 67/141; G06F 3/165

(57) ABSTRACT

A method for enabling a web page running on a web browser of a computing device to communicate data with a prohibited device that is peripheral to the computing device. The method includes establishing an audio communication channel between an audio interface of the prohibited peripheral device and an audio interface of the computing device to emulate communication with an allowed peripheral audio device, by performing at least one of modulating and demodulating the data, and communicating the modulated or demodulated data between the computing device and the prohibited peripheral device over the established audio communication channel, wherein the prohibited peripheral device is not one of a restricted group of allowed peripheral audio devices with which the web browser allows the web page to communicate via the computing device.

### CROSS-REFERENCE TO RELATED APPLICATIONS

This application claims the benefit of prior U.S. Provisional Application Ser. No. 62/023,280, filed Jul. 11, 2014, which is incorporated by reference herein in its entirety.

### BACKGROUND OF THE INVENTION

Modern web pages (sometimes referred to as Web-Applications) are computer programs that are downloaded from remote servers and run on a user's browser. However, such computer programs may provide platform to undesired malware that may be inserted to the legitimate software. In order to limit the effects of such malware browsers prohibit certain operations from web pages. Web pages may control the display, the sound and some user interactions in a browser window, but typically cannot control other windows or software processes running on the same computer.

Similarly, web pages cannot directly control devices connected to the computer. However, control over a list of permitted peripherals is possible through the browser. For example, web pages may communicate with the screen, the keyboard, the mouse, the speakers and microphone as part of their normal functionality.

This security policy, while providing some protection against malware, may limit legitimate functionality of web pages. The solution used today is to use browser extensions such as Java™ Applets, Flash® software or Silverlight® software, that are allowed to break out of the browser's sandbox. However, since those extensions are widely used for malware, they are being limited more and more with time and the trend is to eliminate their use for this purpose altogether.

### SUMMARY OF THE INVENTION

According to embodiments of the present invention there is provided a method for enabling a web page running on a web browser of a computing device to communicate data with a prohibited device that is peripheral to the computing device, the method may include: establishing an audio communication channel between an audio interface of the prohibited peripheral device and an audio interface of the computing device to emulate communication with an allowed peripheral audio device, by performing at least one of modulating and demodulating the data; and communicating the modulated or demodulated data between the computing device and the prohibited peripheral device over the established audio communication channel, wherein the prohibited peripheral device is not one of a restricted group of allowed peripheral audio devices with which the web browser allows the web page to communicate via the computing device.

Furthermore, according to embodiments of the present invention, the audio interface of the prohibited peripheral device may include an audio connector configured to be plugged into an audio socket of the computing device, and the data may be communicated over at least one audio line of the audio socket and the audio connector.

Furthermore, according to embodiments of the present invention, the audio interface of the prohibited peripheral device may be configured to be wirelessly connected to the audio interface of the computing device.

Furthermore, according to embodiments of the present invention, exchanging data may include transmitting data from the web browser to the prohibited peripheral device and from the prohibited peripheral device to the web browser.

Furthermore, according to embodiments of the present invention, the prohibited peripheral device may be an authentication device.

Furthermore, according to embodiments of the present invention, the prohibited peripheral device may be selected from the group consisting of: controllable gate, controllable door, computer controllable home appliance, joystick, game controller, smart card reader, a sensor and a Bluetooth device.

Furthermore, according to embodiments of the present invention, the prohibited peripheral device may include a converter configured to relay communication between the web page and another device using a communication protocol that is selected from Universal Serial Bus (USB), RS232, Bluetooth, Bluetooth Low Energy (BLE) and Wi-Fi.

Furthermore, according to embodiments of the present invention, the method may include using a cryptographic mechanism to execute an operation selected from: authenticating the prohibited peripheral device, authenticating the web page, authenticating a web server supporting the web page, authenticating messages communicated between the web page and the prohibited peripheral device using a signature, and encrypting the content of messages communicated between the web page and the prohibited peripheral device.

Furthermore, according to embodiments of the present invention, the method may include embedding a library in, or linking a library to the web page to handle communication between the web page and the prohibited peripheral device over the audio communication channel.

Furthermore, according to embodiments of the present invention, the web page may be adapted to use the library to execute functionality selected from: modulation of data over the audio communication channel, demodulation of data from the audio communication channel, error detection, error correction, retransmission, authentication, and encryption.

According to embodiments of the present invention there is provided a computing device. The computing device may include: an audio interface for connecting to an audio interface of a prohibited device that is peripheral to the computing device; and a processor to: operate a web page within a web browser, wherein the web page may communicate data with the prohibited peripheral device by: establishing an audio communication channel between an audio interface of the prohibited peripheral device and an audio interface of the computing device to emulate communication with an allowed audio device by performing at least one of modulating and demodulating the data; and communicating the data between the computing device and the prohibited peripheral device over the established audio communication channel, wherein the prohibited peripheral device is not one of a restricted group of allowed audio devices with which the web browser allows the web page to communicate via the computing device.

According to embodiments of the present invention there is provided a peripheral device configured to connect to a computing device, the computing device operating a web browser. The peripheral device may include: an audio interface for connecting to an audio interface of the computing device; and a processor configured to: establish an audio communication channel between the audio interface of the peripheral device and the audio interface of the computing device to emulate communication with an allowed peripheral audio device, by performing at least one of modulating and demodulating the data; and communicate the data between the computing device and the peripheral device over the established audio communication channel, wherein the peripheral device is not one of a restricted group of allowed peripheral audio devices with which the web browser allows the web page to communicate via the computing device.

According to embodiments of the present invention, the peripheral device may be an authentication device.

According to embodiments of the present invention, the peripheral device may be a converter configured to relay communication between the web page and another peripheral device using a communication protocol that is selected from the group consisting of: Universal Serial Bus (USB), RS232, Bluetooth, Bluetooth Low Energy (BLE) and Wi-Fi.

According to embodiments of the present invention, the peripheral device may use a cryptographic mechanism to execute an operation selected from: authenticating the web-page, authenticating the web-server, authenticating the integrity of messages flowing between the web page and the peripheral device using a signature, and encrypting the content of those messages.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of an example prior art system;

FIG. 2 is a schematic illustration of an example system for enabling a web page to access prohibited peripheral device which is blocked by web browser according to embodiments of the present invention;

FIG. 3 is a schematic illustration of an example system for enabling web page to receive input from prohibited peripheral device which is blocked by web browser, according to embodiments of the present invention;

FIG. 4 is a schematic illustration of an example system for enabling web page to send output to prohibited peripheral device which is blocked by web browser, according to embodiments of the present invention;

FIG. 5 is a schematic illustration of an example system for enabling web page to access device which is blocked by web browser, according to embodiments of the present invention;

FIG. 6 is a schematic illustration of an example system for enabling a web page to access prohibited peripheral device which is blocked by web browser according to embodiments of the present invention; and

FIG. 7 is a flowchart of a method for enabling a web page to access devices blocked by a web browser according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the present invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the present invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed at the same point in time.

Conventional web browsers running on a computing device typically support communication with a restricted group of peripheral devices (“allowed peripherals”) via one or more communication channels (“allowed communication channels”) and block or do not support communication with other peripheral devices (“prohibited peripherals”). According to an embodiment of the invention, a web page running on a web browser of a computing device may communicate data with a prohibited peripheral device that is not one of the restricted group of allowed peripherals by emulating or mimicking communication as if it were sent by an allowed peripheral. The prohibited peripheral and/or a web page may send and/or receive information to/from each other, for example, by modulating/demodulating that information over an audio communication channel to emulate communication with an allowed peripheral audio device. As used herein, a peripheral device is a device that is separable from and/or independently operable of the computing device, for example, connected via an audio socket or wireless audio interface thereof. As used herein, an audio device is an allowed peripheral that is configured to communicate audio signals over an audio channel with the computing device, such as an external microphone or an external speaker.

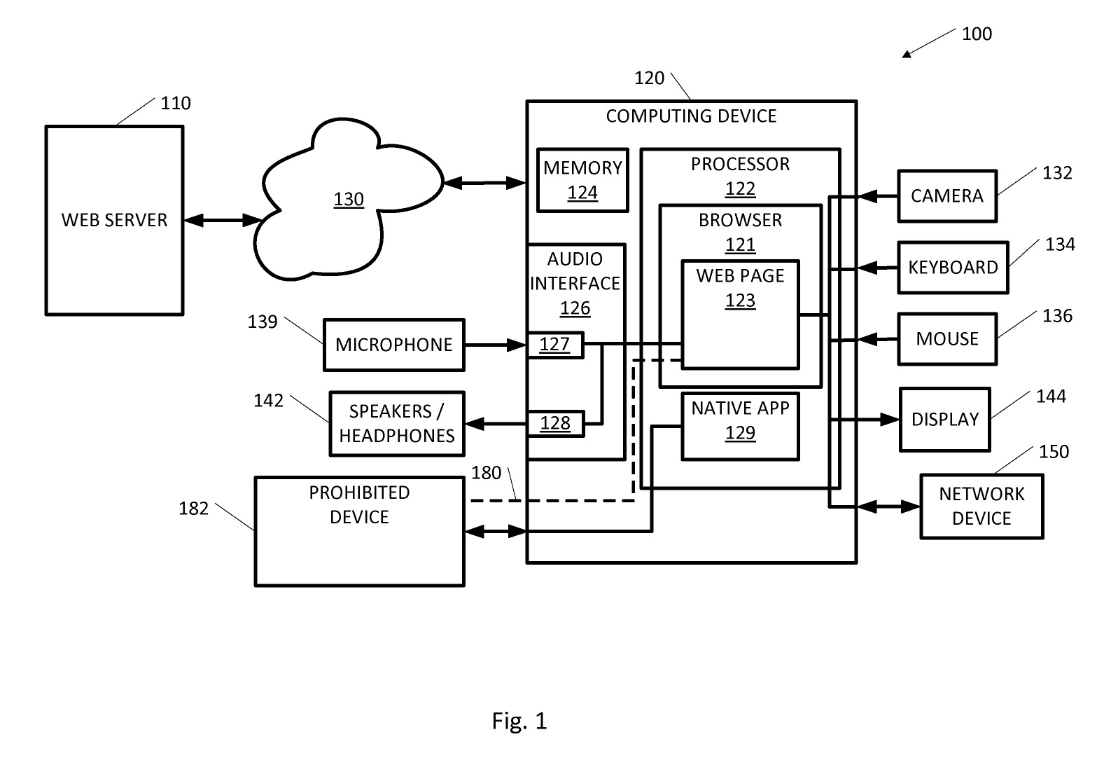

Reference is made to FIG. 1, which schematically illustrates an example system 100. System 100 may include a computing device 120 that may be configured to communicate with web server 110 over a network 130 such as the Internet. Computing device 120 may run browser software 121 that may download web pages 123 and retrieve other information from web server 110, present web pages 123 to the user, receive input from the user and send back data to web server 110. As used herein web pages 123 may be software code downloadable from remote servers such as web server 110 and containing code that may run on user's browser 121. Computing device 120 may also run native applications 129.

According to embodiments of the invention, computing device 120 may be any applicable computing device and may include or may be, for example, a personal computer, a desktop computer, a mobile computer, a laptop computer, a notebook computer, a terminal, a workstation, a server computer, a tablet computer, a smart phone, a wearable device or any other suitable computing device. Computing device 120 may include processor 122 and memory unit 124. Processor 122 may be configured to execute commands included in a program, algorithm or code stored in memory 124. Processor 122 may include components such as, but not limited to, one or more central processing units (CPU), a digital signal processor (DSP), a controller, a chip, a microchip, a field-programmable gate array (FPGA), an application-specific integrated circuit (ASIC) or any other integrated circuit (IC), or any other suitable multi-purpose or specific processor or controller, one or more input units, one or more output units or any other suitable hardware components and/or software components. Processor 122 may be any computation device that is configured to execute various operations included in some methods disclosed herein. Memory 124 may be a non-transitory computer-readable storage medium that may store thereon instructions that when executed by processor 122, cause processor 122 to perform operations and/or methods, for example, the method disclosed herein.

Computing device 120 may be connected to one or more peripheral devices (also referred to herein as “peripherals”). Web pages 123 that run on user's browser 121 of computing device 120 may access a list of peripherals, referred herein as “permitted” or “allowed” peripherals, as defined in applicable standards, such as HyperText Markup Language (HTML) 5. The list of permitted peripherals that web page 123 may access may include input peripherals such as microphone 139, camera 132, keyboard 134 and mouse 136, output peripherals such as display 144 and speakers/headphones 142, and input/output peripherals such as network device 150. Thus, web pages 123 may display data on display 144, get input from keyboard 134, mouse 136 and camera 132, play audio on speakers/headphones 142 and receive audio from microphone 139, and have bidirectional communication with network device 150. Speakers/headphones 142 and microphone 139 may be included in single headset.

Computing device 120 may be connected to other devices, which are not in the group of permitted peripherals. The devices which are not in the group of permitted or allowed peripherals are referred to herein as “prohibited” devices, such as prohibited device 182. The prohibited devices 182 may be accessed by native application 129, but may be blocked by web browser 121 which may disable access of web pages 123 to prohibited devices 182. Web pages 123 may not communicate with prohibited devices 182, and may not control those devices. Communication over connection 180 is typically not supported in prior art devices, but is now made possible according to embodiments of the present invention as described in detail herein.

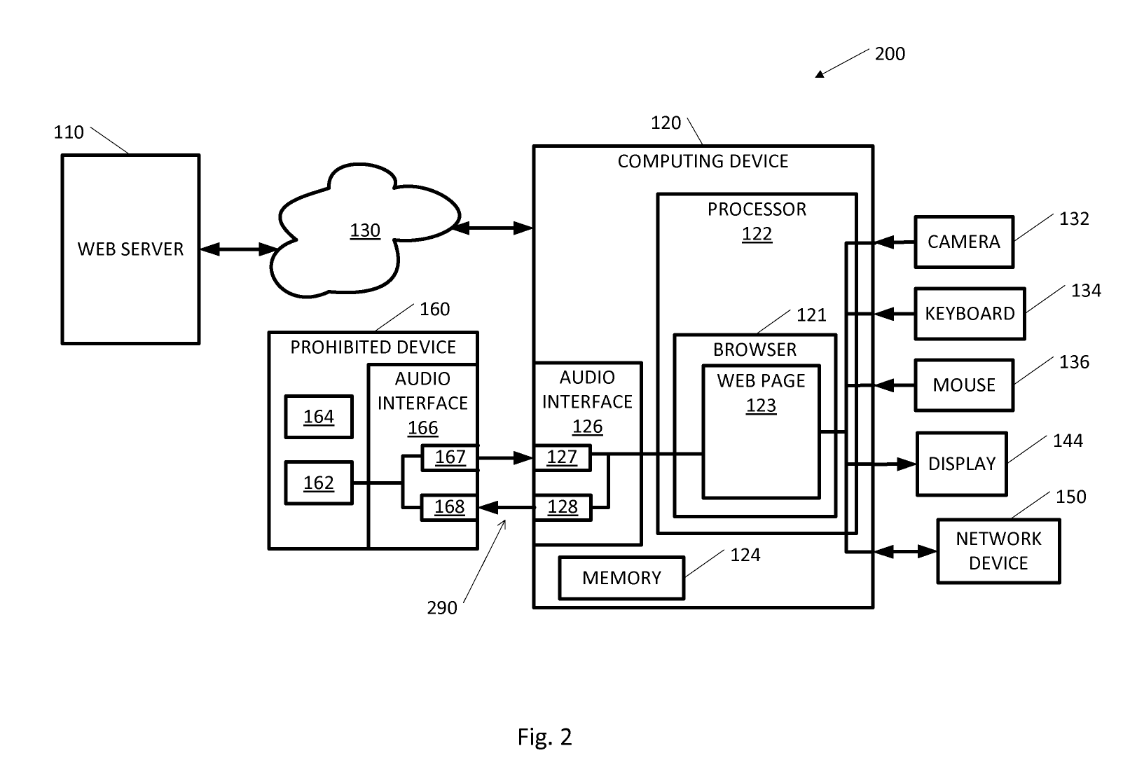

Reference is made to FIG. 2, which schematically illustrates an example system 200 for enabling a web page 123 executed by computing device 120 to communicate with prohibited device 160, which is a peripheral device to computing device 120 that is blocked by web browser 121 over audio communication channel 290, according to embodiments of the present invention. Similar components depicted in several figures are given same reference numerals.

According to embodiments of the present invention, prohibited device 160 may be configured to emulate communication characteristics of one or more audio device that are allowed by web browser 121 to communicate with web page 123, by establishing a unidirectional or bidirectional audio communication channel 290 with web page 123 through an audio channel, and by communicating data with web page 123 through audio communication channel 290. Prohibited device 160, which does not typically communicate over allowed audio channels, may be emulated to be an allowed audio peripheral, such as, a microphone or speaker, by converting the prohibited device's non-audio data to audio data sent over an allowed audio channel. The computing device and prohibited device may establish an audio communication channel 290 by modulating and demodulating data over the audio channel. According to embodiments of the present invention, bidirectional communication channel between web page 123 and prohibited device 160 may be established by emulating communication characteristics of more than one audio devices, for example, by emulating communication characteristics of a permitted output audio device such as a speaker or a headphone to transmit data from web page 123 to prohibited device 160, and emulating communication characteristics of a permitted input audio device such as a microphone to transmit data from prohibited device 160 to web page 123. Prohibited device 160 may emulate both physical characteristics and communication protocol layer characteristics of the one or more allowed audio devices.

Prohibited device 160 may include any device that may be configured to or adapted to communicate with web page 123 through the audio communication channel 290 according to embodiments of the present invention, and is not included in the list of allowed or permitted peripherals. Prohibited device 160 may include input devices, output devices and input/output devices. The list of the prohibited devices is practically endless. Examples may include controllable gates and doors, computer controllable home appliances such as air conditioners, lights, electric curtains, washing machines, etc., joysticks and game controllers, authentication tokens, for example those used to authenticate identity of a bank account users or email users, etc., contact or contactless (e.g., NFC) payment devices, smart card readers used for Europay®, MasterCard® and Visa® (EMV) payment, and all other smartcard usages, Magnetic Stripe readers, converters to other communication protocol like Universal Serial Bus (USB), RS232, BlueTooth, Bluetooth Low Energy (BLE), Wi-Fi, etc., a variety of sensors such as heat sensors, humidity sensors, proximity sensors, volume sensors, pressure sensors, etc.

Prohibited device 160 may include a wired or wireless audio interface 166 that is configured to be connected to audio interface 126 of computing device 120. Audio interface 126 of computing device 120 may include one or more audio-in interfaces 127 and one or more audio-out interfaces 128. Audio interface 166 of prohibited device 160 may include one or more audio-in interfaces 168 and one or more audio-out interfaces 167. Prohibited device 160 may be connected to computing device 120 via a dedicated socket or sockets, such as a separated input audio jack for audio-in interface 127 and an output audio jack for audio-out interface 128, a single audio jack for both audio in audio-out interfaces 127, 128, or a multipurpose socket such as Universal Serial Bus (USB), or via a wireless link, as known in the art. For example, prohibited device 160 may include a 35 mm audio connector including both audio-in and audio-out interfaces 167, 168, which may be configured to be plugged into a corresponding audio socket or inlet of computing device 120. Currently, most mobile phones and laptops include a 35 mm audio inlet. Alternatively, prohibited device 160 may include a single connector (e.g. a 2-pin connector) to connect to computing device 120 with separate audio-in and audio-out sockets. In case prohibited device 160 does not include an audio connector, prohibited device 160 may be connected to computing device 120 using a convertor (not shown), e.g. Audio-to-USB, Audio-to-Serial, Audio-to-Bluetooth, that may allow prohibited device 160 to communicate with web page 123.

Prohibited device 160 may include processor 162 and memory unit 164. Processor 162 may be configured to execute commands included in a program, algorithm or code stored in memory 164. Processor 162 may include components such as, but not limited to, one or more central processing units (CPU), a digital signal processor (DSP), a controller, a chip, a microchip, a field-programmable gate array (FPGA), an application-specific integrated circuit (ASIC) or any other integrated circuit (IC), or any other suitable multi-purpose or specific processor or controller, one or more input units, one or more output units or any other suitable hardware components and/or software components. Processor 162 may be any computation device that is configured to execute various operations included in some methods disclosed herein. Memory 164 may be a non-transitory computer-readable storage medium that may store thereon instructions that when executed by processor 162, cause processor 162 to perform operations and/or methods, for example, the method disclosed herein. It should be noted that processor 162 and memory unit 164 are optional components of prohibited device 160 and according to some embodiments of the present application prohibited device 160 may be activated by a signal initiated by web page 123 or send an analog signal to web page 123 without using a processor. For example, if prohibited device 160 includes a sensor, the analog signal produced by the sensor may be sent to web page 123, or if prohibited device 160 includes an appliance, an on/off signal may be sent from web page 123 to the appliance.

According to embodiments of the present invention, establishing an audio communication channel 290 between web page 123 and prohibited device 160 may require adjustments of web page 123 as well as of prohibited device 160. Thus, both web page 123 and prohibited device 160 may be preprogrammed, configured for, or adapted to establish the audio communication channel 290 over the audio channel and communicate data over the established audio communication channel 290. Hence, this method for communication between prohibited device 160 and web page 123 may not impose severe security problems since web page 123 may not activate in this manner prohibited devices that where not designed intentionally to be activated by web page 123.

According to embodiments of the present invention, prohibited device 160 may establish an audio communication channel 290 with web page 123 by emulating communication characteristics of an audio peripheral, e.g., emulating communication characteristics of speakers/headphone 142 to transmit data from web page 123 to prohibited device 160, and emulating communication characteristics of microphone 139 to transmit data from prohibited device 160 to web page 123. Digital data communicated between web page 123 and prohibited device 160 may be modulated over and demodulated from the audio signal. For example, modulating and demodulating data over the audio signal may be performed using the relatively new HTML5 Web Audio Application Programming Interface (API) which is used for processing and synthesizing audio in web applications. The functionality of modulating and demodulating data over the audio signal may be encapsulated in a script library (for example JavaScript library) that is embedded into web page 123 or linked by web page 123. The script library may also handle other operations related to communicating the data such as error detection, error correction, encryption, authentication, power supply, detection of a state of prohibited device 160, e.g., detection whether the device is connected, communicating, and/or plugged in or out, etc.

Prohibited device 160 may emulate both physical characteristics and communication protocol layer characteristics of a permitted audio device. For example, in some embodiments establishing an audio communication channel 290 between an audio interface of the prohibited device and an audio interface of the computing device may also include a handshaking protocol. Prohibited device 160 may be connected via a headset jack or via separated microphone jack and speakers jack, to computing device 120 having corresponding sockets. The headset jack may be any standard stereo headset jack such as the 35 mm stereo jack supporting, for example, two output audio channels—LS and RS, and one input audio channel—MIC. Prohibited device 160 may receive from web page 123 via the headset jack of computing device 120 audio signals received over audio-out interface 128 and audio in interface 168, such as RS channel for right speaker and LS channel for left speaker. Prohibited device 160 may transmit to web page 123 audio signals over audio out interface 167 and audio-in interface 127 such as microphone input (MIC). Alternatively, prohibited device 160 may emulate other wired audio channels or a wireless audio connection with computing device 120, using, for example, Bluetooth communication protocol.

An audio-out interface 128 of computing device 120 and audio-in interface 168 of prohibited device 160 may be used to establish an audio-out communication channel, and audio-in interface 127 of computing device 120 and audio-out interface 167 of prohibited device 160 may be used to establish an audio-in communication channel, together forming a two way audio communication channel 290 for processor 162, to communicate with web page 123 through computing device 120.

Web page 123 and prohibited device 160 may modulate data over the audio channel using any applicable modulation method such as Amplitude Modulation, Frequency Modulation, Phase Modulation, Pulse Position Modulation, On-Off Keying, etc. Combinations of modulation methods may also be used and different modulation methods may be used for different applications. Sending and receiving signals by web page 123 may be done with using Web Audio API which supports sufficient data rates. Sending data may also be achieved, for example, using the html tags <embed>, <object> and/or <audio>. Processor 162 may be adapted or configured to communicate with web page 123 by receiving audio signals modulated with digital data and/or instructions and by extracting the digital data from the audio modulated signal received on the audio-out channel, for example, on audio channel RS. Processor 162 may be further adapted to modulate audio signal with data and send it over the audio-in channel to web page 123 running on the browser of computing device 120. The types of data that may be exchanged between prohibited device 160 and web page 123 are application dependent.

According to embodiments of the present invention, web page 123 and prohibited device 160 may use error detection methods to detect errors in the data. Web page 123 and prohibited device 160 may use retransmission mechanisms in order to overcome errors. Web page 123 and prohibited device 160 may change audio-level parameters in response to errors in order to prevent additional errors. Web page 123 and prohibited device 160 may use error correction mechanisms to fix transmission errors without retransmission.

According to embodiments of the present invention, web page 123 and prohibited device 160 may use cryptographic mechanisms to authenticate prohibited device 160, web page 123 and web server 110. Web page 123 and prohibited device 160 may use cryptographic mechanisms to sign the messages flowing between them (signature), or to encrypt the content of those messages.

According to some embodiments the data communicated between prohibited device 160 and web page 123 over the audio channel may include an analog signal. For example, an activation signal may be sent from web page 123 to prohibited device 160 or, if prohibited device 160 includes a sensor, the analog signal produced by the sensor may be sent to web page 123. Thus, the analog signal may be modulated and demodulated over audio communication channel 290. In some embodiments, the analog signal may be rectified or adjusted.

In some embodiments, prohibited device 160 may include an internal power source (not shown). Additionally or alternatively, the audio-out channel, for example an LS channel, may be used to provide energy for the operation of prohibited device 160. The power required for the operation of prohibited device 160 may be delivered to a power supply unit (not shown) of prohibited device 160 via the audio-out channel in the form of a specific audio signal, hereinafter denoted powering signal. The powering signal may be in a defined frequency or in a range of frequencies and it may have defined amplitude or it may be in a defined range of amplitudes. According to some embodiments a second audio-out channel, for example, an RS channel, may be used in conjunction with the LS channel for providing additional powering to prohibited device 160, hence increasing the available power supply for prohibited device 160. In such case the data and power signals may be combined in suitable way over one or more of the audio-out channel. The power supply unit of prohibited device 160 may boost, rectify and regulate the powering signal received over one or more audio-out channels to provide the required power for the operation of prohibited device 160. According to some embodiments of the present invention, when the audio signal received from the audio-out channel is not within the defined frequency and/or level limitations, the power supply unit may not activate prohibited device 160 and/or processor 162 will be in off mode. Audio powering signal may be initiated and provided by web page 123, for example, by the execution of a dedicated program embedded within web page 123 running on browser 121, and may be provided to prohibited device 160 via the audio-out socket of computing device 120 to which an audio jack of prohibited device 160 may be attached or plugged. According to some embodiments, the powering audio signal may differ in its frequency range and/or in its amplitude range from the frequency range and/or the amplitude range, respectively, of the typical audio signal provided by computing device 120 during normal operation of an audio device. Prohibited device 160 may include a passive interface circuit (not shown) that may comprise, for example, resistors and capacitors, and may be used to mutually adapt and match the amplitudes and DC levels of the signals exchanged between processor 162 and computing device 120.

Authentication of identity of users of web page 123 using a username and a password may have multiple weaknesses. Specifically, this type of authentication is considered easy to breach. Therefore, major web sites require hardware tokens as stronger means of authentication. However, since hardware authentication tokens are not included in the list of permitted peripherals, many browsers prohibit access of web pages based applications to authentication tokens. Thus many web sites use One time Password (OTP) tokens, which provide a password to the user, which the user has to manually type into the window of the web site. This solution has disadvantages with regard to user experience and speed. Alternatively, the user's phone may be used as an OTP token: sites send the user a code in Short Message Service (SMS), essentially using the phone's Subscriber Identity Module (SIM) card as the second factor of authentication. Some Mobile OTP implementations use a secure web connection instead of SMS.

According to embodiments of the present invention, prohibited device 160 may be or may include an authentication device. The authentication device may include a cryptographic enabled Secure Element that may communicate with a web page 123 to implement secure hardware-based cryptographic authentication of their users. These embodiments may allow companies who have substantial and sensitive interactions with end-users through their web-sites (like email providers, social network providers, content providers, banks, government institutes, etc.) to authenticate those end-users. Allowing web page 123 to communicate with an authentication device through an audio channel, by emulating communication characteristics of an audio device may allow web page 123 and the authentication device to use two-way authentication protocols in which each party can present a challenge (random or unpredictable data) to the other party—which then needs to sign that challenge. Such protocols have better protection against replay attacks than one-way protocols.

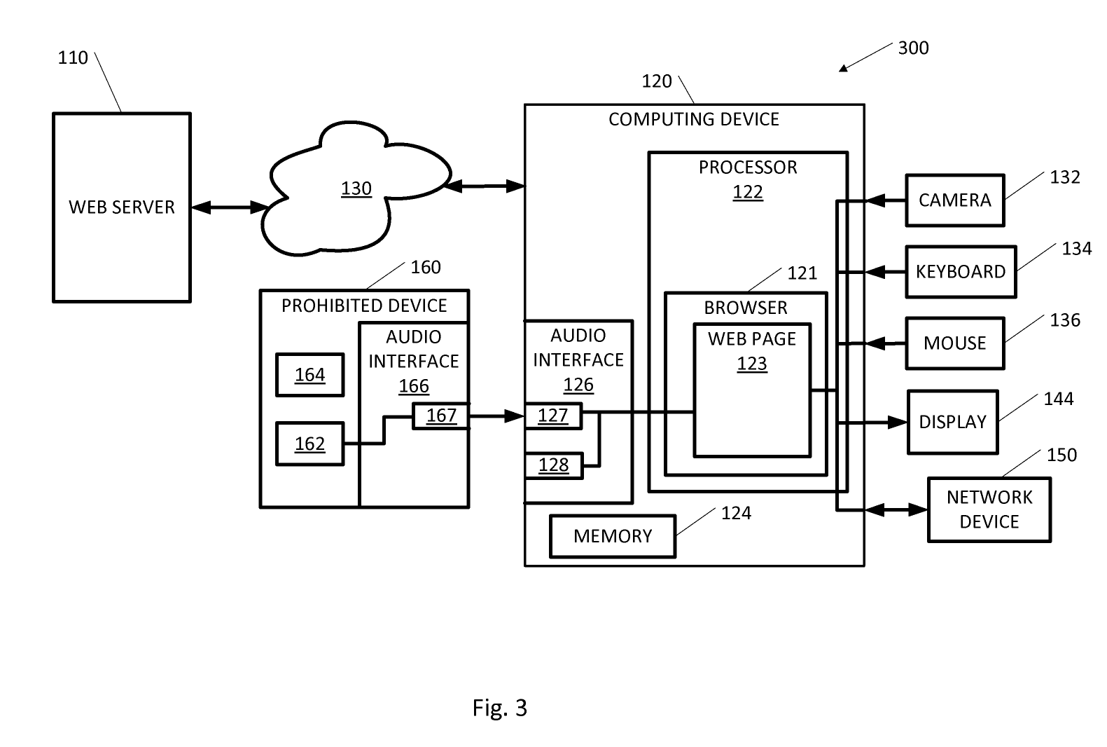

Reference is made to FIG. 3, which schematically illustrates an example system 300 for enabling web page 123 to receive input from prohibited device 160 which is blocked by web browser 121, according to embodiments of the present invention. System 300 may be generally similar to system 200, except for using only the audio-in channel for receiving at web page 123 data or signals sent from prohibited device 160. In this embodiment prohibited device 160 may include an input device such as Magnetic Stripe reader, a joystick, a game controller, a sensor, etc.

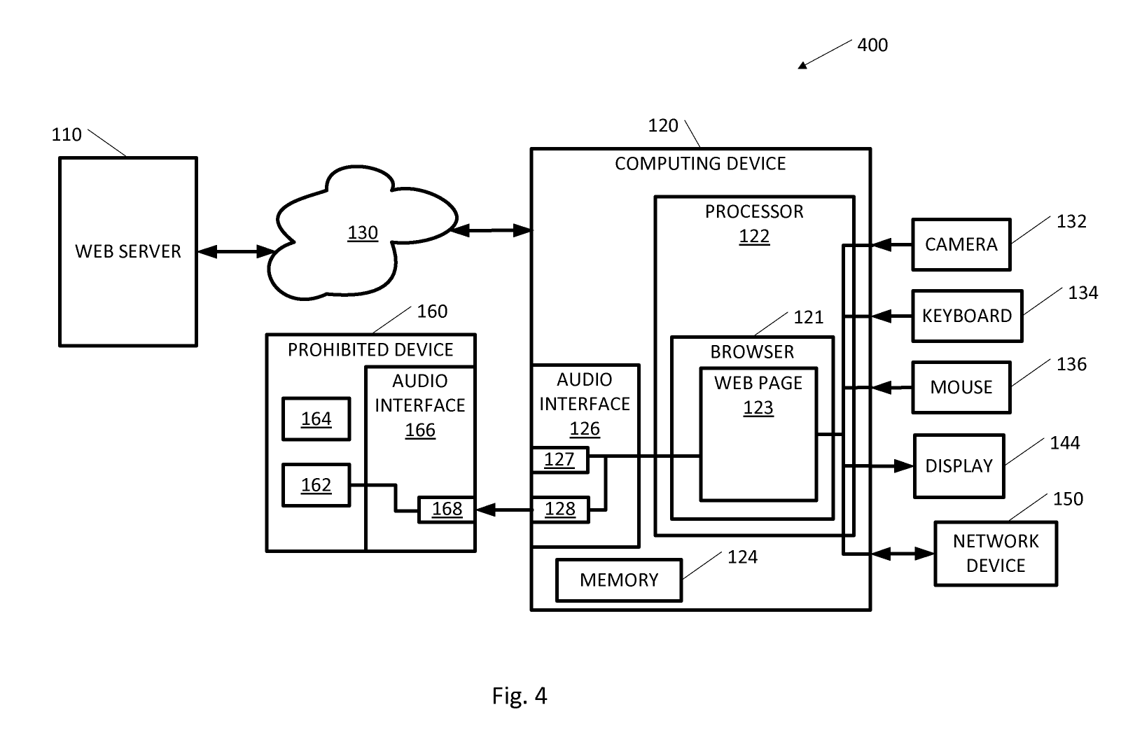

Reference is made to FIG. 4, which schematically illustrates an example system 400 for enabling web page 123 to send output to prohibited device 160 which is blocked by web browser 121, according to embodiments of the present invention. System 400 may be generally similar to system 200, except for using only the audio-out channel for sending data or signals from web page 123 to prohibited device 160. In this embodiment, prohibited device 160 may include an output device such as controllable gates and doors, computer controllable home appliances such as air conditioners, lights, electric curtains, washing machines, etc.

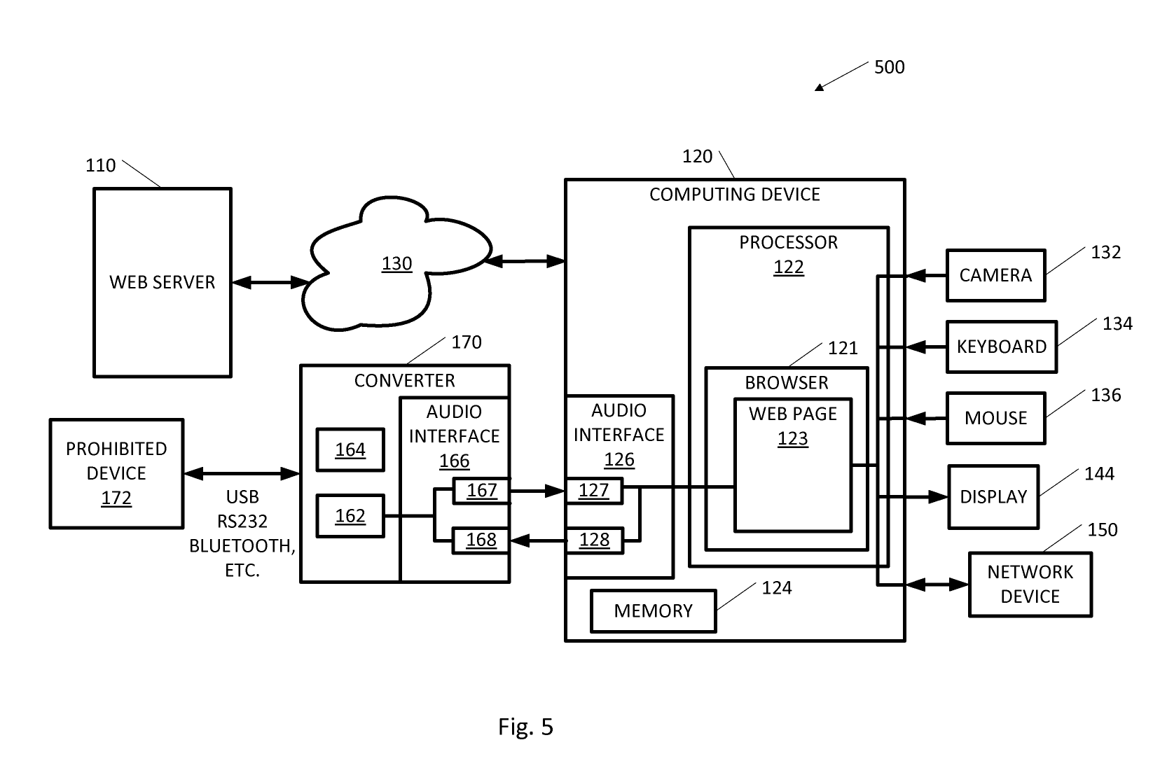

Reference is made to FIG. 5, which schematically illustrates an example system 500 for enabling web page 123 to access peripheral device 172 which is blocked by web browser 121, according to embodiments of the present invention. System 500 may be generally similar to system 200, however, in this embodiment peripheral device 172 does not include an audio interface or does not use its audio interface to communicate with computing device 120. According to this embodiment, the prohibited device includes a converter 170 that may exchange data with web page 123 through an audio channel, according to embodiments of the present invention, and may relay communication between web page 123 and peripheral device 172 using a communication protocol supported by peripheral device 172. Converter 170 may convert data transmitted and/or received over audio interface 126 into and from other communication types like USB, RS232, BlueTooth, BLE, Wi-Fi, etc. and communicate with peripheral device 172.

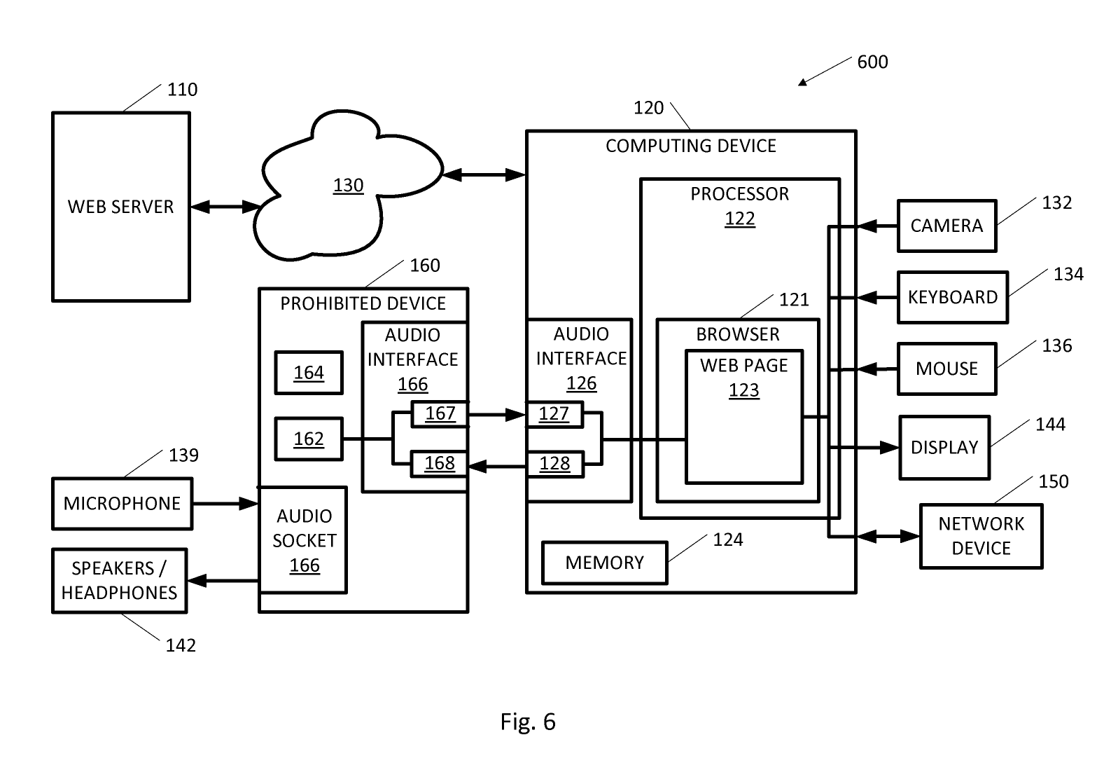

Reference is made to FIG. 6, which schematically illustrates an example system 600 for enabling a web page 123 to access prohibited device 160 which is blocked or not supported by web browser 121 according to embodiments of the present invention. According to embodiments of the present invention prohibited device 160 may include an audio socket 166, such as a 35 mm audio socket or any other audio socket or sockets as may be required. Audio socket 166 may enable a user to connect an audio device to prohibited device 160. Flow of data from audio interface 126 may be controlled by a mechanical switch (not shown) or a software switch to direct audio data either to prohibited device 160 or via prohibited device 160 to an audio device enabling the user to enjoy the audio channel for its original purpose when prohibited device 160 is not used.

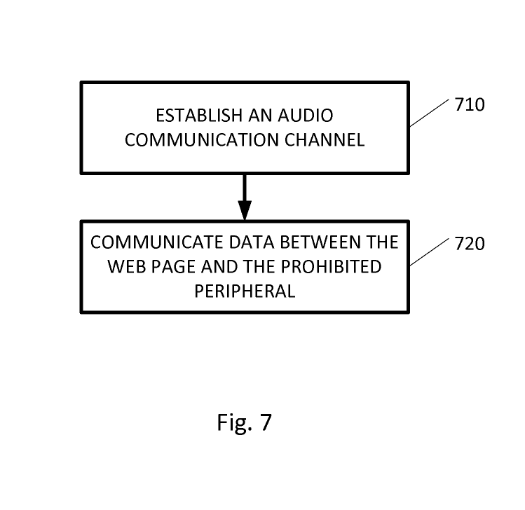

Reference is now made to FIG. 7 which is a flowchart illustration of a method for enabling a web page to access devices blocked by a web browser according to embodiments of the present invention.

In operation 710 an audio communication channel may be established between the web page and prohibited device 160. The web page and/or prohibited device 160 may convert non-audio data into audio data for transmission over the audio channel by performing at least one of modulating and demodulating the data. Thus prohibited device 160 may emulate communication characteristics of an audio device or a plurality of audio devices. Prohibited device 160 may emulate both physical characteristics and communication protocol layer characteristics of one or more allowed audio devices. Thus, the web page may transmit and receive data to and from the prohibited device, by pretending that the prohibited device is an audio device or a plurality of audio devices. The communication channel may include input only communication channel, output only communication channel or bidirectional input/output communication channel. An input only communication channel may be achieved by emulating communication characteristics of a permitted input audio device such as a microphone. An output only communication channel emulating communication characteristics of a permitted output audio device such as a speaker or a headphone. A bidirectional input/output communication channel may be achieved by emulating communication characteristics of both a permitted input audio device such as a microphone and a permitted output audio device such as a speaker or a headphone.

In operation 720 data is communicated, e.g., transmitted and/or received, between the web page executed by the communication device and prohibited device 160 over the established audio channel.

Using the audio channel for establishing a communication channel between a web page and a prohibited device may provide substantial advantages over other methods. For example, this method supports input only channel, output only channel, or a bi-direction input/output communication channel (two-way communication), for both analog signals and digital signals modulated over an audio signal. This solution is convenient for users since this solution is not platform specific, an audio channel is typically supported by all consumer computers and no installation of driver on the computer may be required. From the service provider perspective, working in a web page makes installation and deployment easier compared to native or packaged applications. In addition, plug-in connection does not rely on Internet or wireless connectivity, network communications may not be interrupted and the hardware of the prohibited device may be relatively inexpensive, for example, compared to a network router.

Some embodiments of the present invention may be implemented in software for execution by a processor-based system, for example, the method for enabling a web page to access peripherals blocked by a web browser. For example, embodiments of the present invention may be implemented in code or software and may be stored on a non-transitory computer-readable storage medium having stored thereon instructions which, when executed by a processor, cause the processor to perform methods as discussed herein, and can be used to program a system to perform the instructions. The non-transitory computer-readable storage medium may include, but is not limited to, any type of disk including floppy disks, optical disks, compact disk read-only memories (CD-ROMs), rewritable compact disk (CD-RW), and magneto-optical disks, semiconductor devices such as read-only memories (ROMs), random access memories (RAMs), such as a dynamic RAM (DRAM), Ferroelectric RAM (F-RAM), erasable programmable read-only memories (EPROMs), flash memories, electrically erasable programmable read-only memories (EEPROMs), magnetic or optical cards, or any type of media suitable for storing electronic instructions, including programmable storage devices. Other implementations of embodiments of the present invention may comprise dedicated, custom, custom made or off the shelf hardware, firmware or a combination thereof.

Embodiments of the present invention may be realized by a system that may include components such as, but not limited to, a plurality of central processing units (CPU) or any other suitable multi-purpose or specific processors or controllers, a plurality of input units, a plurality of output units, a plurality of memory units, and a plurality of storage units. Such system may additionally include other suitable hardware components and/or software components.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for enabling a web page running on a web browser of a computing device to communicate data with a prohibited device that is peripheral to the computing device, the method comprising:
establishing an audio communication channel between an audio interface of the prohibited peripheral device and an audio interface of the computing device to emulate communication with an allowed peripheral audio device, by performing at least one of modulating and demodulating the data; and
communicating the modulated or demodulated data between the computing device and the prohibited peripheral device over the established audio communication channel,
wherein the prohibited peripheral device is not one of a restricted group of allowed peripheral audio devices with which the web browser allows the web page to communicate via the computing device.

2. The method of claim 1, wherein the audio interface of the prohibited peripheral device comprises an audio connector configured to be plugged into an audio socket of the computing device, and wherein the data is communicated over at least one audio line of the audio socket and the audio connector.

3. The method of claim 1, wherein the audio interface of the prohibited peripheral device is configured to be wirelessly connected to the audio interface of the computing device.

4. The method of claim 1, wherein exchanging data comprises transmitting data from the web browser to the prohibited peripheral device and from the prohibited peripheral device to the web browser.

5. The method of claim 1, wherein the prohibited peripheral device is an authentication device.

6. The method of claim 1, wherein the prohibited peripheral device is selected from the group consisting of: controllable gate, controllable door, computer controllable home appliance, joystick, game controller, smart card reader, a sensor and a Bluetooth device.

7. The method of claim 1, wherein the prohibited peripheral device comprises a converter configured to relay communication between the web page and another device using a communication protocol that is selected from the group consisting of: Universal Serial Bus (USB), RS232, Bluetooth, Bluetooth Low Energy (BLE) and Wi-Fi.

8. The method of claim 1 comprising using a cryptographic mechanism to execute an operation selected from the group consisting of: authenticating the prohibited peripheral device, authenticating the web page, authenticating a web server supporting the web page, authenticating messages communicated between the web page and the prohibited peripheral device using a signature, and encrypting the content of messages communicated between the web page and the prohibited peripheral device.

9. The method of claim 1 comprising embedding a library in or linking a library to the web page to handle communication between the web page and the prohibited peripheral device over the audio communication channel.

10. The method of claim 9, wherein the web page is adapted to use the library to execute functionality selected from the group consisting of: modulation of data over the audio communication channel, demodulation of data from the audio communication channel, error detection, error correction, retransmission, authentication, and encryption.

11. A computing device comprising:
an audio interface for connecting to an audio interface of a prohibited device that is peripheral to the computing device; and
a processor to:
operate a web page within a web browser, wherein the web page communicates data with the prohibited peripheral device by:
establishing an audio communication channel between an audio interface of the prohibited peripheral device and an audio interface of the computing device to emulate communication with an allowed audio device by performing at least one of modulating and demodulating the data; and
communicating the data between the computing device and the prohibited peripheral device over the established audio communication channel,
wherein the prohibited peripheral device is not one of a restricted group of allowed audio devices with which the web browser allows the web page to communicate via the computing device.

12. A peripheral device configured to connect to a computing device, the computing device operating a web browser, the peripheral device comprising:
an audio interface for connecting to an audio interface of the computing device; and
a processor configured to:
establish an audio communication channel between the audio interface of the peripheral device and the audio interface of the computing device to emulate communication with an allowed peripheral audio device, by performing at least one of modulating and demodulating the data; and
communicate the data between the computing device and the peripheral device over the established audio communication channel,
wherein the peripheral device is not one of a restricted group of allowed peripheral audio devices with which the web browser allows the web page to communicate via the computing device.

13. The peripheral device of claim 12, wherein the audio interface of the peripheral device comprises at least one audio connector configured to be plugged into at least one audio socket of the computing device, and wherein the data is exchanged over at least one audio line of the at least one audio socket.

14. The peripheral device of claim 12, wherein the audio interface of the peripheral device is configured to be connected to the audio interface of the computing device wirelessly.

15. The peripheral device of claim 12, wherein the peripheral device is an authentication device.

16. The peripheral device of claim 12, wherein the peripheral device comprises a converter configured to relay communication between the web page and another peripheral device using a communication protocol that is selected from the group consisting of: Universal Serial Bus (USB), RS232, Bluetooth, Bluetooth Low Energy (BLE) and Wi-Fi.

17. The peripheral device of claim 12, wherein the peripheral device uses a cryptographic mechanism to execute an operation selected from the group consisting of: authenticating the web-page, authenticating the web-server, authenticating the integrity of messages flowing between the web page and the peripheral device using a signature, and encrypting the content of those messages.
